(19) United States
(12) Patent Application Publication
(10) Pub. No.: US 2002/0041260 A1
(43) Pub. Date: Apr. 11, 2002

(54) System and method of operator control

(76) Inventor: Norbert Grassmann, Regensburg (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/925,971

(22) Filed: Aug. 10, 2001

(30) Foreign Application Priority Data
Aug. 11, 2000 (DE) 100 39 432.9

(51) Int. Cl. G09G 5/00

(52) U.S. Cl. 345/7

(57) ABSTRACT

Operator control, in particular for operating switches in a motor vehicle with a low level of distraction, having a sensor for sensing the position of an input element which is controlled manually by an operator, and a visual display unit which is arranged in the operator's field of vision and displays at least one virtual operator element. An evaluation unit which is connected to the sensor on the input side determinines the position of the manually controlled input element and has an image generator which is connected to the evaluation unit on the input side and to the display unit on the output side and displays a virtual image pointer in the operator's field of vision in accordance with the position of the manually controlled operator element.

### CLAIM FOR PRIORITY

This application claims priority to German Patent Application No. 10039432.9 filed on Aug. 11, 2000, the disclosure of which is incorporated by reference in its entirety.

### TECHNICAL FIELD OF THE INVENTION

The invention relates to an operator control, in particular for operating switches in a motor vehicle with a low level of distraction, in accordance with the preamble of claim 1.

### BACKGROUND OF THE INVENTION

German patent DE 196 53 595 C1 discloses an operator control which permits the driver of a motor vehicle to activate switches without having to divert his attention from the road. For this purpose, the operator control has a video camera which is directed at the switches to be activated, and records an image of the switches and of the driver's hand. This image is projected into the field of vision of the driver with the operator control by means of a “head-up” display, so that the driver can determine the position of his hand relative to the switches to be activated without diverting his attention from the road. In this way, equipment which is arranged in the interior of the motor vehicle (for example air conditioning system, radio, navigation system, telephone) can be operated without endangering road safety. Furthermore, the previously mentioned patent discloses how virtual operator elements, such as switches, are projected into the field of vision of the driver by means of the head-up display so that the number of actually embodied switches is reduced.

However, one disadvantage of the operator control described above is that the video camera not only records the driver's hand and the operator elements to be activated, but also part of the center console, for example. The center console, unfortunately, impairs the vision of the driver when they are faded into the driver's field of vision. Additionally, the driver's hand may be covering the switching elements to be activated from the video camera's line of vision such that even fading the driver's hand into his field of vision does not permit satisfactory operation to be carried out.

### SUMMARY OF THE INVENTION

In one embodiment of the invention, an operator control for operating switches in a motor vehicle. The operator control, for example, a sensor to sense the position of an input element which is controlled manually by an operator, a visual display unit which is arranged in the operator's field of vision and displays at least one virtual operator element, an evaluation unit which is connected to the sensor on the input side and determinines the position of the manually controlled input element and an image generator which is connected to the evaluation unit on the input side and to the display unit on the output side and displays a virtual image pointer in the operator's field of vision in accordance with the position of the manually controlled operator element.

In one aspect of the invention, the evaluation unit is connected on the output side to a comparator unit which compares the position determined by the evaluation unit with predefined position data and generates a control signal as a result of the comparison.

In another aspect of the invention, the operator control includes a loudspeaker to perform audible confirmation of a possible activation, and/or an activation which has taken place of a virtual operator element, the loudspeaker being connected to the comparator unit for activation.

In yet another aspect of the invention, the evaluation unit is connected on the output side to a limiter which limits the position data determined by the evaluation unit to predefined values.

In still another aspect of the invention, the limiter is connected on the output side to a loudspeaker in order to output an audible warning signal when the predefined position data are reached or exceeded.

In one aspect of the invention, the sensor is an optical sensor, an ultrasonic sensor, a radar sensor, a capacitive sensor or a contact sensor.

In another aspect of the invention, the sensor is a video camera, an infrared video camera or a touchpad.

In still another aspect of the invention, the visual display unit is a head-up display.

In another embodiment of the invention, there is a method for operator control of operating switches in a motor vehicle. The method includes, for example, sensing the position of an input element which is controlled manually by an operator, displaying at least one virtual operator element in the operator's field of vision, determining the position of the manually controlled input element; and displaying a virtual image pointer in the operator's field of vision in accordance with the position of the manually controlled operator element.

In one aspect of the invention, the method for operator control of operating switches in a motor vehicle includes, for example, performing audible confirmation of a possible activation, and/or an activation which has taken place of a virtual operator element, the loudspeaker being connected to the comparator unit for activation.

### BRIEF DESCRITPION OF THE DRAWINGS

Other advantageous of the invention are explained below with reference to the figures together with the description of the preferred exemplary embodiment of the invention. In the figures:

FIG. 1 shows a perspective view of the interior of a motor vehicle with the operator control according to the invention.

FIG. 2 shows the operator control according to the invention as a block circuit diagram.

FIG. 3 shows an exemplary embodiment of the invention with a touchpad as sensor.

### DETAILED DESCRIPTION OF THE INVENTION

The invention discloses improving an operator control so as to reduce disruptive image components which are faded into the driver's field of vision, and an operator control which is ergonomic.

In one embodiment of the invention, the image of the driver's hand is recorded by the video camera, but is not faded directly into the driver's field of vision. Rather, it is used to determine the position of the driver's hand. In accordance with the determination of the position of the driver's hand, a virtual image pointer is then faded into the driver's field of vision by a visual display unit. In this regard, disruptive optical background signals in the image recorded by the video camera, such as parts of the center console, are faded out.

Accordingly, the operator control according to the invention has a sensor which senses the position of an input element which is controlled manually by the operator. The input element can be, for example, the operator's hand or index finger. However, it is also possible for the operator to hold a separate input element which interacts with the sensor in order to permit the position to be determined. A video camera, such as an infrared camera, an ultrasonic sensor, a radar sensor, a capacitive sensor or a contact sensor, (i.e. what is commonly referred to as a touchpad) is preferably suitable here as sensor.

Furthermore, the operator control according to the invention has a visual display unit which is arranged in the operator's field of vision and displays at least one virtual operator element and the virtual image pointer. The display unit preferably includes a head-up display which can project an image directly into the operator's field of vision.

Moreover, in the operator control according to the invention, an evaluation unit which is connected to the sensor on the input side and which determines the position of the manually controlled input element is provided.

Finally, an image generator is provided, which is connected to the evaluation unit on the input side and to the display unit on the output side. The image generator displays a virtual image pointer in the operator's field of vision in accordance with the position of the manually controlled operator element.

In a preferred embodiment of the invention, the evaluation unit is connected on the output side to a comparator unit. The comparator unit compares the position, determined by the evaluation unit, of the manually controlled operator element with predefined position data and generates a control signal as a function of the result of the comparison. The predefined position data preferably corresponds to the positions of the individual virtual switching elements to be activated, such that the user moves the manually controlled input element into a desired spatial region in order to trigger a switch activation.

Preferably, the comparator unit is connected on the output side to a loudspeaker in order to audibly display a possible activation, and/or an activation which has taken place, of a virtual operator element. In this way, it is possible, for example, to give the operator audible feedback by outputting an audible signal if the manually controlled input element is located in an activation position in front of a switching element. The operator knows, for example, that the manually controlled input element, such as an index finger, merely has to be pressed toward the front in order to activate the operator element, after which a further audible element is then output, which preferably differs from the first audible signal, in order to indicate that the operator element has been activated.

In another embodiment of the invention, the evaluation unit is connected on the output side to a limiter which limits the position data, determined by the evaluation unit, of the manually controlled input element to predefined values. In this way, it is possible, for example, to prevent the virtual image pointer faded into the operator's field of vision from moving out of the operator's field of vision when he makes a hand movement which misses the mark. The virtual image pointer instead remains at the limits of the field of vision in order to facilitate repositioning by the operator. The limiter is also preferably connected on the output side to a loudspeaker in order to give the operator audible feedback so that the loudspeaker outputs an audible warning signal if the operator's hand moves out of the operator control region.

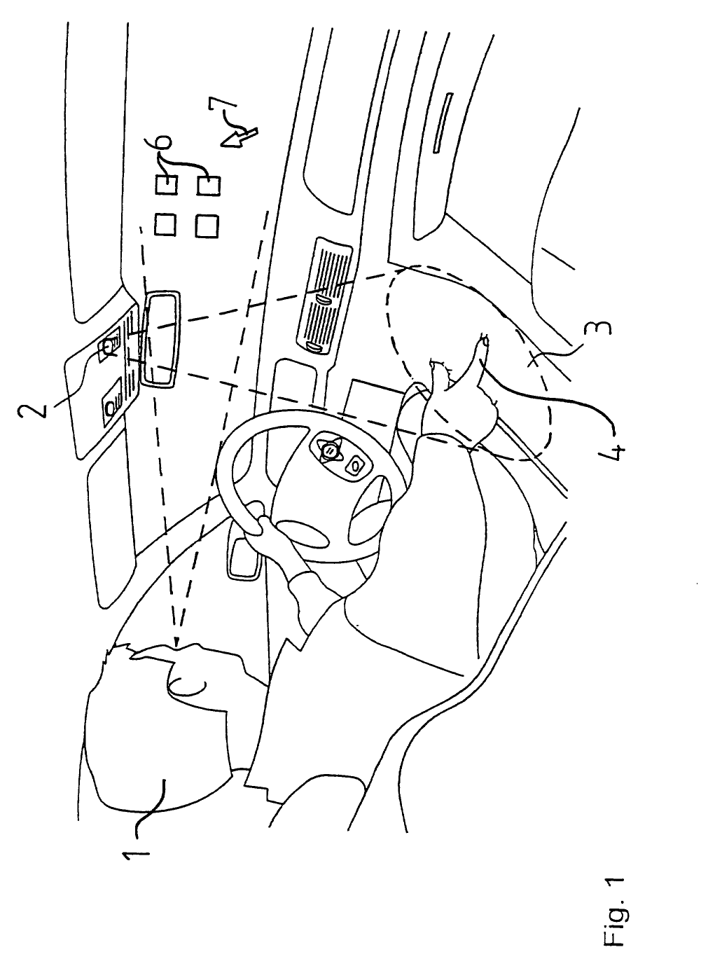

The perspective view illustrated in FIG. 1 shows a motor vehicle interior with a driver 1 and a video camera 2 which is arranged in the roof lining above the center console and which is directed downward onto an operator control area 3 lying in the region of the center console. The operator control area 3 includes, in contrast to conventional operator controls, no switching elements or operator elements which are actually embodied. Rather, they serve as a contact face for an index finger 4 of the driver 1, which serves as an input element. The image of the operator control area 3, which is picked up by the video camera 2, includes, as information, the position of the driver's index finger 4.

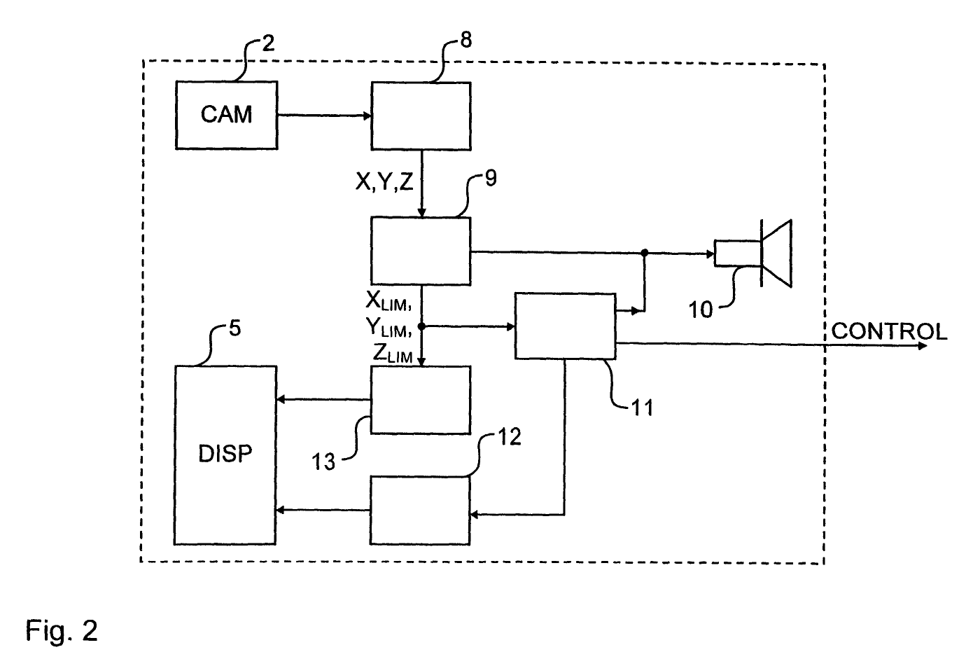

Furthermore, the operator control according to the invention has a head-up display 5 which is illustrated schematically in FIG. 2. The structure of such a head-up display 5 is described in detail in German laid-open application DE 196 20 199 A1. On the one hand, the head-up display 5 fades virtual operator elements 6 into the field of vision of the driver 1, and the virtual operator elements 6 can be virtual switches, for example. On the other hand, the head-up display 5 projects a virtual image pointer 7 into the field of vision of the driver 1.

The video camera 2 is connected on the output side to an image analyzing unit 8 which serves as an evaluation unit and which analyzes the image of the hand of the driver 1 which is picked up by the video camera 2, and determines the spatial position of the tip of the index finger 4 and outputs it in the form of position data X, Y, Z.

A limiter 9 is connected downstream of the image analyzing unit 8 and compares the position data X, Y, Z, calculated by the image analyzing unit 8, of the tip of the index finger with predefined position data which limit the operator control area 3. If the driver 1 moves his/her index finger 4 out of the operator control area, the position data X, Y, Z of the tip of the index finger 4 are limited to the limiting values X_{LIM}, Y_{LIM}, Z_{LIM} at the boundaries of the operator control area 3.

Furthermore, the limiter 9 is connected on the output side to a loudspeaker 10 which outputs an audible warning signal if the user's hand leaves the operator control area 3.

On the output side, the limiter 9 is connected to a comparator unit 11 which compares the limited position data X_{LIM}, Y_{LIM}, Z_{LIM} with predefined position data, which correspond to the virtual positions of the operator element 6. If the driver 1 moves his/her index finger 4 in such a way that the tip of the index finger 4 is located in the region of the virtual positions of the switching elements 6, the comparator unit 11 outputs a corresponding control signal CONTROL in order to trigger the function which is associated with the respective operator element 6. In this case, the comparator unit 11 activates the loudspeaker 10 in order to generate an audible feedback signal which indicates to the driver 1 that the respective operator element 6 has been successfully activated. In addition, the comparator unit 11 is connected on the output side to an image generator 12, which drives the head-up display 5 so as to display the virtual operator elements 6. The operator element activated by the driver 1 is displayed in a different color after successful activation, such that the driver 1 receives not only an audible feedback signal by the loudspeaker 10, but also a visual feedback signal as a result of the operator element 6 being achieved in a different color in the head-up display 5.

The operator control according to the invention also has an image generator 13 which is connected on the input side to the limiter 9, and drives the head-up display 5 so as to display the virtual image pointer 7 as a function of the position data X_{LIM}, Y_{LIM} and Z_{LIM} limited by the limiter 9.

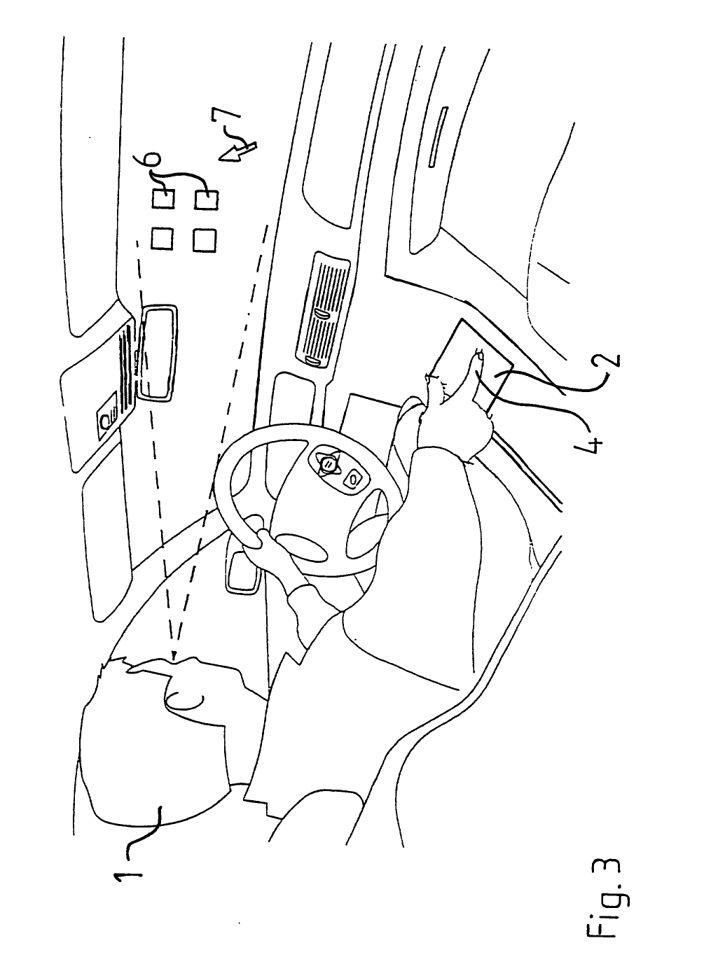

The exemplary embodiment illustrated in FIG. 3 coincides largely with the exemplary embodiment described above and shown in FIGS. 1 and 2, so that in what follows the same reference symbols are used and reference is made to the above description in order to avoid repetitions.

The particular feature of the exemplary embodiment according to FIG. 3 is that the sensor 2 is not a video camera, but rather a touch-sensitive touchpad which outputs the position at which the driver touches the touchpad.

The invention is not restricted to the exemplary embodiment described above. Instead, it is possible to conceive of a multiplicity of variants and modifications which make use of the idea according to the invention and therefore also fall within the scope of protection.

What is claimed is:

1. An operator control for operating switches in a motor vehicle, comprising:
a sensor to sense the position of an input element which is controlled manually by an operator;
a visual display unit which is arranged in the operator's field of vision and displays at least one virtual operator element;
an evaluation unit which is connected to the sensor on the input side and determinines the position of the manually controlled input element; and
an image generator which is connected to the evaluation unit on the input side and to the display unit on the output side and displays a virtual image pointer in the operator's field of vision in accordance with the position of the manually controlled operator element.

2. The operator control as claimed in claim 1, wherein the evaluation unit is connected on the output side to a comparator unit which compares the position determined by the evaluation unit with predefined position data and generates a control signal as a result of the comparison.

3. The operator control as claimed in claim 2, further comprising a loudspeaker to perform audible confirmation of a possible activation, and/or an activation which has taken place of a virtual operator element, the loudspeaker being connected to the comparator unit for activation.

4. The operator control as claimed in claim 1, wherein the evaluation unit is connected on the output side to a limiter which limits the position data determined by the evaluation unit to predefined values.

5. The operator control as claimed in claim 4, wherein the limiter is connected on the output side to a loudspeaker in order to output an audible warning signal when the predefined position data are reached or exceeded.

6. The operator control as claimed in claim 1, wherein the sensor is an optical sensor, an ultrasonic sensor, a radar sensor, a capacitive sensor or a contact sensor.

7. The operator control as claimed in claim 6, wherein the sensor is a video camera, an infrared video camera or a touchpad.

8. The operator control as claimed in claim 1, wherein the visual display unit is a head-up display.

9. A method for operator control of operating switches in a motor vehicle, comprising:
sensing the position of an input element which is controlled manually by an operator;
displaying at least one virtual operator element in the operator's field of vision;
determining the position of the manually controlled input element; and
displaying a virtual image pointer in the operator's field of vision in accordance with the position of the manually controlled operator element.

10. The method as claimed in claim 9, further comprising performing audible confirmation of a possible activation, and/or an activation which has taken place of a virtual operator element, the loudspeaker being connected to the comparator unit for activation.
